(19) United States
(12) Patent Application Publication
(10) Pub. No.: US 2025/0080250 A1
(43) Pub. Date: Mar. 6, 2025

(54) METHOD FOR ESTIMATING CHANNEL PARAMETERS OF RECONFIGURABLE INTELLIGENT SURFACE CHANNELS BASED ON SPHERICAL WAVE ASSUMPTION

(71) Applicants: Southeast University, Nanjing (CN); PURPLE MOUNTAIN LABORATORIES, Nanjing (CN)

(72) Inventors: Chengxiang WANG, Nanjing (CN); Yingjie XU, Nanjing (CN); Yingzhuo SUN, Nanjing (CN); Jialing HUANG, Nanjing (CN); Lijian XIN, Nanjing (CN); Jie HUANG, Nanjing (CN)

(21) Appl. No.: 18/816,830

(22) Filed: Aug. 27, 2024

(30) Foreign Application Priority Data
Aug. 30, 2023 (CN) 2023110992642

(51) Int. Cl. H04B 17/309; H04B 7/10

(52) U.S. Cl. CPC H04B 17/309; H04B 7/10

(57) ABSTRACT

A method for estimating channel parameters of a reconfigurable intelligent surface based on a spherical wave assumption includes the following steps. In Step 1, a signal transmission model of a RIS-assisted near-field communication is constructed based on the spherical wave assumption; in Step 2, channel measurement data in different RIS transmission modes are obtained; in Step 3, a delay, an angle of arrival, an angle of departure, a Doppler shift and a polarization matrix of multipath in channels are estimated based on a space-alternating generalized expectation maximization algorithm, and angle parameters, distance parameters and coupling polarization matrices of the multipath at a RIS end are estimated based on a maximum likelihood principle; and in Step 4, the estimated parameters are updated and iterated subsequently. The method can estimate all important channel parameters in the RIS-assisted near-field communication scenario more accurately.

### TECHNICAL FIELD

The present disclosure relates to the technology field of wireless communication, particularly relates to a method for estimating parameters of a reconfigurable intelligent surface channel based on a spherical wave assumption.

### BACKGROUND

In order to achieve the vision of global-coverage, full spectra, full-applications, full digital, full sense and strong network, the 6th-generation (6G) mobile communication system is expected to introduce a potentially key technology of Reconfigurable Intelligent Surfaces (RIS). In the RIS-assisted communication environment, in order to achieve more accurate directional control and stronger reflected beam gain, the applied RIS is commonly designed to carry more electromagnetic reflection unit cells. At this time, the size of the RIS is further increased, which means that it has a larger Rayleigh distance, and the transmitter, the receiver and the scatterers in the environment are more likely to be located in the RIS near-field region, then the spherical-wavefront propagation characteristics of the signal reaching different electromagnetic reflection unit unit cells of the RIS can no longer be approximated to plane waves.

Different algorithms for estimating channel parameters have been proposed in prior art. In previous studies, a parameter estimation algorithm based on the space-alternating generalized expectation maximization (SAGE) was proposed to estimate the delay, the angle of arrival, the angle of departure, the Doppler shift and the complex amplitude of the multipath component in the channel, and the angles of incidence and reflection at the RIS end. However the disadvantage is that it is assumed that the signal propagates between the RIS and the transmitter and receiver side in the form of plane, then the estimations of distance parameters and coupling polarization matrix parameters of the RIS in its near-field region are neglected, therefore the channel characteristics for the near-field region of the RIS are difficult to be characterized accurately.

### SUMMARY

The objectives of the present disclosure are to provide a method for estimating channel parameters of a reconfigurable intelligent surface channel based on a spherical wave assumption so as to solve the technical problems in the prior art that cannot comprehensively estimate all channel parameters of the RIS near-field channel.

In order to solve the above-mentioned technical problems, the technical solutions provided in the present disclosure are specifically as follows.

In Step 1, a signal transmission model of a reconfigurable intelligent surface (RIS)-assisted near-field communication is constructed based on the spherical wave assumption.

In Step 2, channel measurement data in different RIS transmission modes are obtained.

In Step 3, a delay, an angle of arrival, an angle of departure, a Doppler shift and a polarization matrix of multipath components in channels are estimated based on a space-alternating generalized expectation maximization algorithm, and angle parameters, distance parameters and coupling polarization matrices of the multipath components at a RIS end are estimated based on a maximum likelihood principle.

In Step 4, estimated parameters are updated and iterated subsequently. Step 1 specifically includes the following steps.

In Step 101, an existing RIS-assisted MIMO wireless communication environment is considered, antenna arrays with scales of Mₜ and Mᵣ are equipped at a transmitter (Tx) and a receiver (Rx) respectively. The RIS is set as a planar array formed by M_{RIS}=Mₓ×M_{y} passive electromagnetic reflection unit cells with irregular reflection functions. A total of L multipath components are set to interact with the RIS in a channel environment, and propagation characteristics of the L multipath components are affected by the RIS and a whole propagation link of transmitter (Tx)-RIS-receiver (Rx) is divided into sub-links of transmitter-RIS and RIS-receiver, polarization matrices in each of the sub-links are represented as Aₗ^{Tx-RIS} and Bₗ^{RIS-Rx}. In the wireless communication environment, a signal vector s^{RIS}(t;θₗ) is expressed as follows:

$${{s}^{}}^{RIS} ( t ; {θ}_{l} ) = {[ {s}_{1}^{{}_{RIS}} ( t ; {θ}_{l} ) , … , {s}_{{M}_{r}}^{{}_{RIS}} ( t ; {θ}_{l} ) ]}^{T} = exp \{ j 2 π {v}_{l} t \} {C}_{r} ( {Ω}_{l}^{r} ) {\underbrace{{{[ {B}_{l}^{RIS - Rx} ]}^{T} [ \begin{matrix}0 & {G}_{2} \\ {G}_{1} & 0\end{matrix} ] [ {A}_{l}^{Tx - RIS} ]}^{T}}}_{{A}_{l}} \cdot {{C}_{t} ( {Ω}_{l}^{t} )}^{T} u ( t - {τ}_{l} ) ,$$

where u(t)=[u₁(t), u₂(t), . . . , u_{M}_{ₜ}(t)]^{T} denotes transmitting signals, θₗ denotes a set of parameters in an l-th path formed by a delay τₗ, an angle of departure Ωₗ^{t}, an angle of arrival Ωₗ^{r}, a Doppler shift νₗ and a polarization matrix Aₗ, and the polarization matrix Aₗ includes complex amplitude information of horizontal and vertical polarization directions, Cᵣ(Ωₗ^{r})≐[C_{r,1}(Ωₗ^{r}), C_{r,2}(Ωₗ^{r})]∈ [symbol] ^{M}^{ᵣ}^{×2} denotes antenna response at the receiver, Cₜ(Ωₗ^{t})≐[C_{t,1}(Ωₗ^{t}), C_{t,2}(Ωₗ^{t})]∈ [symbol] ^{M}^{ₜ}^{×2} denotes antenna response at the transmitter, the antenna responses to the transmitter are measured in a microwave darkroom, G₁ denotes responses of the RIS to incoming waves from a horizontal polarization direction, G₂ denotes responses of the RIS to incoming waves from a vertical polarization direction.

In Step 102, in a setting of a RIS near-field spherical wave, for the transmitter-RIS link, electromagnetic waves from the transmitter (or other scatterers in the environment) arrive at different electromagnetic reflection cells of the RIS at different angles, and values for the angles are related to positions of the electromagnetic reflection unit cells on the RIS. An electromagnetic reflection unit cell at a center position is set as a reference unit cell, and a position vector of the reference unit cell is expressed as r̅_{RIS}; a position vector of an m-th reflection unit cell on the RIS is expressed as r_{RIS,m}. For a path l passing through a scatterer (or ejected from the transmitter) to the RIS, a position vector of the scatterer in the RIS coordinate system is expressed as s_{in,l}, and a distance between the the scatterer and a center of the RIS is d_{in,l}, and the d_{in,l} is less than a Rayleigh distance of the RIS, and a reference angle of incidence from the path l to the reference unit cell on the RIS is Ω̅ₗ^{RIS,1}, then the position vector of the scatterer s_{in,l} is denoted as: s_{in,l}=−d_{in,l}Ω̅ₗ^{RIS,1}.

Further, according to the position vector r_{RIS,m} of the m-th reflection unit cell, Ω̅ₗ^{RIS,1} and d_{in,l}, an angle of incidence from the path l to the m-th electromagnetic reflection unit cell on the RIS is obtained as follows:

$${Ω}_{l , m}^{RIS , 1} = \frac{( {r}_{RIS , m} - {\overline{r}}_{RIS} ) - {s}_{in , l}}{‖ ( {r}_{RIS , m} - {\overline{r}}_{RIS} ) - {s}_{in , l} ‖} = \frac{( {r}_{RIS , m} - {\overline{r}}_{RIS} ) + {d}_{in , l} {\overline{Ω}}_{l}^{RIS , 1}}{‖ ( {r}_{RIS , m} - {\overline{r}}_{RIS} ) + {d}_{in , l} {\overline{Ω}}_{l}^{RIS , 1} ‖} ,$$

where, ∥⋅∥ denotes a modulo operation. Similarly, an angle of reflection of the path l reflected by the RIS to other scatters (or the receiver) in the RIS-Rx link is related to the positions of the electromagnetic reflection unit cells of the RIS, and an angle of reflection of the path l passing through the m-th electromagnetic reflection unit cell is represented as follows:

$${Ω}_{l , m}^{RIS , 2} = \frac{( {r}_{RIS , m} - {\overline{r}}_{RIS} ) - {s}_{re , l}}{‖ ( {r}_{RIS , m} - {\overline{r}}_{RIS} ) - {s}_{re , l} ‖} = \frac{( {r}_{RIS , m} - {\overline{r}}_{RIS} ) + {d}_{re , l} {\overline{Ω}}_{l}^{RIS , 2}}{‖ ( {r}_{RIS , m} - {\overline{r}}_{RIS} ) + {d}_{re , l} {\overline{Ω}}_{l}^{RIS , 2} ‖} ,$$

where, s_{re,l} denotes a position vector of the scatter, d_{re,l} denotes a distance from the scatterer to the center of the RIS, Ω̅ₗ^{RIS,2} denotes a reference angle of reflection of the path l reflected from the reference unit cell on the RIS to the scatterer; further, RIS guidance vectors c^{RIS,1} and c^{RIS,2} based on spherical wave settings are obtained as follows:

$${C}_{RIS , 1} ( {\overline{Ω}}_{l}^{RIS , 1} , {d}_{i n , l} ) = {[ \begin{matrix}exp \{ \dot{j} 2 π {λ}^{- 1} ( {Ω}_{l , 1}^{RIS , 1} \cdot {r}_{RIS , 1} ) \} \\ … \\ exp \{ \dot{j} 2 π {λ}^{- 1} ( {Ω}_{l , m}^{RIS , 1} \cdot {r}_{RIS , m} ) \} \\ … \\ exp \{ \dot{j} 2 π {λ}^{- 1} ( {Ω}_{l , {M}_{RIS}}^{RIS , 1} \cdot {r}_{RIS , {M}_{RIS}} ) \}\end{matrix} ]}_{{M}_{RIS} \times 1} \\ {C}_{RIS , 2} ( {\overline{Ω}}_{l}^{RIS , 2} , {d}_{re , l} ) = {[ \begin{matrix}exp \{ \dot{j} 2 π {λ}^{- 1} ( {Ω}_{l , 1}^{RIS , 2} \cdot {r}_{RIS , 1} ) \} \\ … \\ exp \{ \dot{j} 2 π {λ}^{- 1} ( {Ω}_{l , m}^{RIS , 2} \cdot {r}_{RIS , m} ) \} \\ … \\ exp \{ \dot{j} 2 π {λ}^{- 1} ( {Ω}_{l , {M}_{RIS}}^{RIS , 2} \cdot {r}_{RIS , {M}_{RIS}} ) \}\end{matrix} ]}_{{M}_{RIS} \times 1} .$$

Further, Step 2 refers to obtaining required channel measurement data through measuring a plurality of times and manually adjusting transmission modes of the RIS each time, the transmission modes of the RIS refer to a set of regulation configurations of tuneable phase-shifts in RIS unit cell arrays.

Further, Step 3 specifically includes the following steps.

In Step 301, channel delays, angles of arrival, angles of departure, Doppler shifts and polarization matrix parameters in different transmission modes are obtained by utilizing received data based on a space-alternating generalized expectation maximization algorithm.

In Step 302, a log-likelihood function of RIS-related parameters is calculated based on a complex amplitude [symbol] estimated in different transmission modes:

$$Λ ( {\overline{Ω}}_{l}^{RIS , 1} , ( {\overline{Ω}}_{l}^{RIS , 2} ; {d}_{i n , l} , {d}_{re , l} ) ∝ {‖ {\hat{\tilde{α}}}_{l} ⊙ exp \{ - j Δ \overline{ψ} \} - {\tilde{A}}_{l} {\tilde{G}}_{l} ‖}^{2} = 2 Re \{ {\tilde{G}}_{l}^{{}_{H}} {\tilde{A}}_{l}^{{}_{H}} ( {\hat{\tilde{α}}}_{l} ⊙ exp \{ - j Δ \overline{ψ} \} ) \} - {\tilde{G}}_{l}^{{}_{H}} {\tilde{A}}_{l}^{{}_{H}} {\tilde{A}}_{l} {\tilde{G}}_{l} ,$$

where Gₗ≐G(Ω̅ₗ^{RIS,1}, Ω̅ₗ^{RIS,2}, d_{in,l}, d_{re,l}, Φ_{p,k}) denotes a response to the RIS, and the response to the RIS is related to an angle of incidence Ωₗ^{RIS,1} and an angle of reflection Ωₗ^{RIS,2} at a RIS end, \tilde{G}ₗ denotes a matrix transformation of Gₗ, Δ\hat{ψ} denotes an estimated value for an initial phase introduced by a plurality of measurements, Ãₗ denotes a matrix transformation of the polarization matrix parameters described in Step 301.

In Step 303, a partial derivative of the log-likelihood function is solved, and it is let that

$$\frac{Λ ( {\overline{Ω}}_{l}^{RIS , 1} , {\overline{Ω}}_{l}^{RIS , 2} ; {d}_{i n , l} , {d}_{re , l} )}{\partial {\tilde{A}}_{l}} = 0$$

such that an objective function for a likelihood estimation of that angle parameters and distance parameters of the RIS is obtained.

In Step 304, the objective function is maximized to obtain an estimated value for additional parameters.

In Step 305, an estimated result of a parametric coupling polarization matrix is obtained based on the estimated values for the angle parameters and the distance parameters of the RIS:

$${\hat{A}}_{l} = {( {\hat{\tilde{G}}}_{l}^{{}_{{}_{{}_{H}}}} {\hat{\tilde{G}}}_{l} )}^{- 1} {\hat{\tilde{G}}}_{l}^{{}_{{}_{{}_{H}}}} {\hat{\tilde{α}}}_{l} ⊙ exp \{ - j Δ \overline{ψ} \} ,$$

where [symbol] ₗ and [symbol] ₗ denote an estimated value for the \tilde{G}ₗ in S302 and an estimated value for the polarization matrix in S301, respectively.

Further, implements of Step 4 are specifically as follows. A parameter set is divided into corresponding parameter subsets, and a continuous updating iteration process of Step E and Step M of the SAGE algorithm are implemented in sequence until the channel parameters are iteratedand converged. A result of a last iteration is an estimated value output by a channel parameter estimation method, Step E is a process of obtaining observed data x_{l,k}(t) in a k-th transmission mode, a method of Step E is as follows:

$${x}_{l , k} ( t ) = {y}_{k} ( t ) - {\sum }_{l}^{L} {s}_{k} ( t ; {\hat{θ}}_{l , k} ) ,$$

where, \hat{θ}_{l,k} denotes a parameter set of an l-th path in the k-th transmission mode estimated in a previous iteration, yₖ(t) denotes received signals obtained in the k-th transmission mode, and Σₗ^{L-1}sₖ(t; \hat{θ}_{l,k}) denotes a sum of signals of other L-1 paths in the environment except the l-th path. Step M is a process of searching parameter values and solving parameter values that maximize the objective function in Step 302.

The method for estimating channel parameters of the reconfigurable intelligent surface based on the spherical wave assumption provided in the present disclosure has the following advantages. For the RIS near-field wireless communication scenario, the present disclosure derives a time-domain signal propagation model based on spherical wave assumption, and utilizes the angle parameters at the RIS end, distance parameters from the RIS to the scatterers and the coupling polarization matrix parameters to characterize the RIS near-field spherical wave propagation characteristics, and provides a corresponding estimation algorithm based on the theory of maximum likelihood estimation and the principle of space-alternating generalized expectation maximization, thereby achieving comprehensive and accurate estimation of all channel parameters in this scenario, which is of great significance for the research of RIS assisted wireless near-field channel characteristics and the improvement of the accuracy of RIS assisted wireless channel modeling.

### BRIEF DESCRIPTION OF THE DRAWINGS

FIG. 1 illustrates a flow diagram of the present disclosure.

FIG. 2 illustrates a schematic diagram of time-division multiplexing time frame structure after RIS transmission mode switching is introduced in the embodiments of the present disclosure.

FIG. 3 illustrates a representation schematic diagram of a root-mean square estimation error in different parameter configurations in the embodiments of the present disclosure.

FIG. 4 illustrates a representation schematic diagram of a root-mean square estimation error of the RIS angle parameters with the iteration numbers in the embodiments of the present disclosure.

FIG. 5 illustrates a representation schematic diagram of a logarithmic likelihood function in different transmission modes in the embodiments of the present disclosure.

### DETAILED DESCRIPTION OF THE EMBODIMENTS

In order to understand the objectives, structures and functions of the present disclosure better, the method for estimating the channel parameters of the reconfigurable intelligent surface based on the spherical wave assumption provided in the present disclosure is further described in detail in conjunction with the drawings.

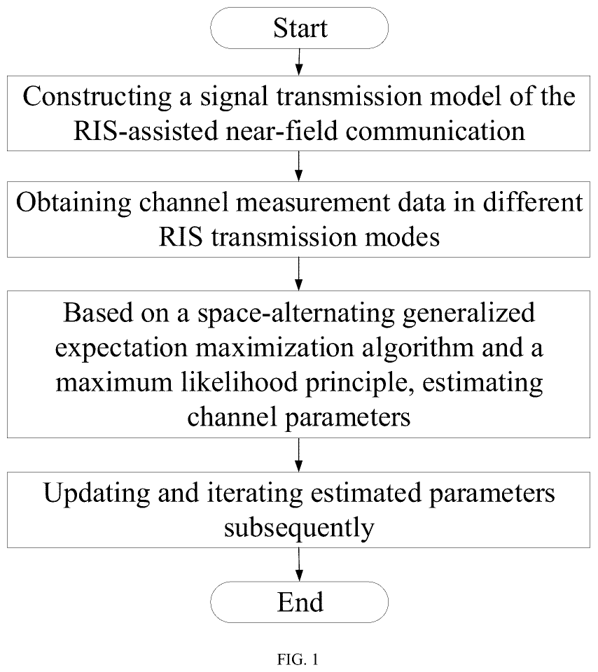

As illustrated in FIG. 1, provided is a method for estimating channel parameters of a reconfigurable intelligent surface based on a spherical wave assumption. The method specifically comprises the following steps.

In Step 1, a signal transmission model of the reconfigurable intelligent surface (RIS)-assisted near-field communication is constructed based on the spherical wave assumption.

In Step 2, channel measurement data in different RIS transmission modes are obtained.

In Step 3, a delay, an angle of arrival, an angle of departure, a Doppler shift and a polarization matrix of multipath components in channels are estimated based on a space-alternating generalized expectation maximization algorithm, and angle parameters, distance parameters and coupling polarization matrices of the multipath components at the RIS end are estimated based on a maximum likelihood principle.

In Step 4, estimated parameters are updated and iterated subsequently. Step 1 specifically includes the following steps.

In Step 101, an existing RIS-assisted MIMO wireless communication environment is considered, antenna arrays with scales of Mₜ and Mᵣ are equipped at a transmitter and a receiver respectively. The RIS is set as a planar array formed by M_{RIS}=Mₓ×M_{y} passive electromagnetic reflection unit cells with irregular reflection functions. A total of L multipaths are set to interact with RIS in a channel environment, and propagation characteristics of the L multipaths are affected by the RIS and a whole transmitter-RIS-receiver propagation link is divided into transmitter-RIS and RIS-receiver sub-links, where the polarization matrices of the sub-links are represented as Aₗ^{Tx-RIS} and Bₗ^{RIS-Rx}, respectively. In the wireless communication environment, a signal vector s^{RIS}(t; θₗ) is represented as follows:

$${s}^{{}_{RIS}} ( t ; {θ}_{l} ) = {[ {s}_{1}^{{}_{RIS}} ( t ; {θ}_{l} ) , … , {s}_{{M}_{r}}^{{}_{RIS}} ( t ; {θ}_{l} ) ]}^{T} = exp \{ j 2 π {v}_{l} t \} {C}_{r} ( {Ω}_{l}^{r} ) {\underbrace{{{[ {B}_{l}^{RIS - Rx} ]}^{T} [ \begin{matrix}0 & {G}_{2} \\ {G}_{1} & 0\end{matrix} ] [ {A}_{l}^{Tx - RIS} ]}^{T}}}_{{A}_{l}} \cdot {{C}_{t} ( {Ω}_{l}^{t} )}^{T} u ( t - {τ}_{l} )$$

where u(t)=[u₁(t), u₂(t), . . . , u_{M}_{ₜ}(t)]^{T} denotes transmitting signals, θₗ denotes a set of parameters of an l-th path formed by a delay τₗ, an angle of departure Ωₗ^{t}, an angle of arrival Ωₗ^{r}, a Doppler shift νₗ and a polarization matrix Aₗ, and the polarization matrix Aₗ includes complex amplitude information of horizontal and vertical polarization directions, Cᵣ(Ωₗ^{r})≐[C_{r,1}(Ωₗ^{r}), C_{r,2}(Ωₗ^{r})]∈ [symbol] ^{M}^{ᵣ}^{×2} denotes antenna response of the receiver, Cₜ(Ωₗ^{t})≐[C_{t,1}(Ωₗ^{t}), C_{t,2}(Ωₗ^{t})]∈ [symbol] ^{M}^{ₜ}^{×2} denotes antenna response of the transmitter, the antenna responses of the transmitter are measured in the microwave darkroom, G₁ denotes responses of the RIS to incoming waves from a horizontal polarization direction, G₂ denotes responses of the RIS to incoming waves from a vertical polarization direction.

In Step 102, in the settings of the RIS near-field spherical wave, for the transmitter-RIS link, electromagnetic waves from the transmitter (or other scatterers in the environment) arrive at different electromagnetic reflection unit cells of the RIS at different angles, and values of the angles are related to the positions of the electromagnetic reflection unit cells on the RIS. The electromagnetic reflection unit cell at a center position is set as a reference unit cell, and a position vector of the reference unit cell is denoted as r̅_{RIS}; a position vector of an m-th reflection unit cell on the RIS is denoted as r_{RIS,m}. For a path l passes through a scatterer (or ejected from the transmitter) to the RIS, a position vector of the scatterer in the RIS coordinate system is s_{in,l}, and a distance between the the scatterer and a center of the RIS is d_{in,l}, and the d_{in,l} is less than a Rayleigh distance of the RIS, and a reference angle of incidence from the path l to the reference unit cell on the RIS is Ω̅ₗ^{RIS,1}, then the position vector of the scatterer s_{in,l} is denoted as: s_{in,l}=−d_{in,l}Ω̅ₗ^{RIS,1}.

Further, according to the position vector r_{RIS,m} of the m-th reflection unit cell, Ω̅ₗ^{RIS,1} and d_{in,l}, an angle of incidence from the path l to the m-th electromagnetic reflection unit cell on the RIS is obtained as follows:

$${Ω}_{l , m}^{RIS , 1} = \frac{( {r}_{RIS , m} - {\overline{r}}_{RIS} ) - {s}_{i n , l}}{‖ ( {r}_{RIS , m} - {\overline{r}}_{RIS} ) - {s}_{i n , l} ‖} = \frac{( {r}_{RIS , m} - {\overline{r}}_{RIS} ) + {d}_{i n , l} {\overline{Ω}}_{l}^{RIS , 1}}{‖ ( {r}_{RIS , m} - {\overline{r}}_{RIS} ) + {d}_{i n , l} {\overline{Ω}}_{l}^{RIS , 1} ‖} ,$$

where, ∥⋅∥ denotes an modulo operation. Similarly, an angle of reflection of path l reflected by the RIS to other scatters (or the receiver) in the RIS-Rx link is related to the positions of the electromagnetic reflection unit cells of the RIS, and an angle of reflection of the path l passing through the m-th electromagnetic reflection unit cell is represented as follows:

$${Ω}_{l , m}^{RIS , 2} = \frac{( {r}_{RIS , m} - {\overline{r}}_{RIS} ) - {s}_{re , l}}{‖ ( {r}_{RIS , m} - {\overline{r}}_{RIS} ) - {s}_{re , l} ‖} = \frac{( {r}_{RIS , m} - {\overline{r}}_{RIS} ) + {d}_{re , l} {\overline{Ω}}_{l}^{RIS , 2}}{‖ ( {r}_{RIS , m} - {\overline{r}}_{RIS} ) + {d}_{re , l} {\overline{Ω}}_{l}^{RIS , 2} ‖} ,$$

where, s_{re,l} denotes a position vector of the scatter, d_{re,l} denotes a distance from the scatterer to the center of the RIS, Ω̅ₗ^{RIS,2} denotes a reference angle of reflection of the path l reflected from the reference unit cell on the RIS to the scatterer; further, RIS guidance vectors c^{RIS,1} and c^{RIS,2} based on spherical wave settings are obtained as follows:

$${C}_{RIS , 1} ( {\overline{Ω}}_{l}^{RIS , 1} , {d}_{i n , l} ) = {[ \begin{matrix}\begin{matrix}exp \{ j 2 {πλ}^{- 1} ( {Ω}_{l , 1}^{RIS , 1} \cdot {r}_{RIS , 1} ) \} \\ ⋯\end{matrix} \\ \begin{matrix}exp \{ j 2 π {λ}^{- 1} ( {Ω}_{l , m}^{RIS , 1} \cdot {r}_{RIS , m} ) \} \\ ⋯\end{matrix} \\ exp \{ j 2 π {λ}^{- 1} ( {Ω}_{l , {M}_{RIS}}^{RIS , 1} \cdot {r}_{RIS , {M}_{RIS}} ) \}\end{matrix} ]}_{{M}_{RIS} \times 1} \\ {C}_{RIS , 2} ( {\overline{Ω}}_{l}^{RIS , 2} , {d}_{re , l} ) = {[ \begin{matrix}\begin{matrix}exp \{ j 2 π {λ}^{- 1} ( {Ω}_{l , 1}^{RIS , 2} \cdot {r}_{RIS , 1} ) \} \\ ⋯\end{matrix} \\ \begin{matrix}exp \{ j 2 π {λ}^{- 1} ( {Ω}_{l , m}^{RIS , 2} \cdot {r}_{RIS , m} ) \} \\ ⋯\end{matrix} \\ exp \{ j 2 π {λ}^{- 1} ( {Ω}_{l , {M}_{RIS}}^{RIS , 2} \cdot {r}_{RIS , {M}_{RIS}} ) \}\end{matrix} ]}_{{M}_{RIS} \times 1} .$$

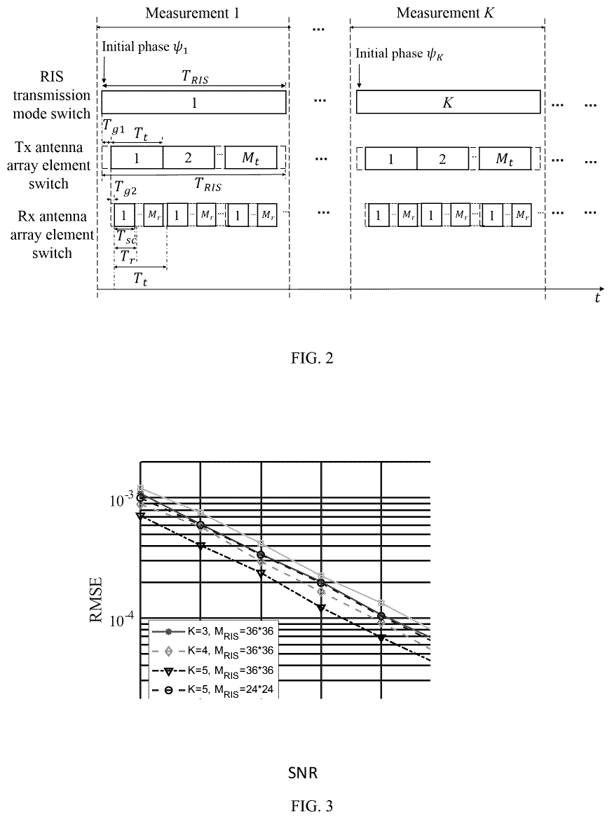

Step 2 refers to obtaining required channel measurement data through measuring a plurality of times and manually adjusting transmission modes of the RIS each time, the transmission modes of the RIS refer to a set of regulation configurations of tuneable phase-shifts in RIS unit cell arrays. A schematic diagram of time-division multiplexing time frame structure after RIS transmission mode switching is introduced as illustrated in FIG. 2.

Further, Step 3 specifically includes the following steps.

In Step 301, channel delays, angles of arrival, angles of departure, Doppler shifts and polarization matrix parameters in different transmission modes are obtained by utilizing received data based on the space-alternating generalized expectation maximization algorithm.

In Step 302, a log-likelihood function of RIS-related parameters is calculated based on the complex amplitudes [symbol] ₗ estimated in different transmission modes:

$$Λ ( {\overline{Ω}}_{l}^{RIS , 1} , {\overline{Ω}}_{l}^{RIS , 2} ; {d}_{i n , l} , {d}_{re , l} ) ∝ {‖ {l}_{} ⊙ exp \{ - j Δ \hat{ψ} \} - {\tilde{A}}_{l} {\tilde{G}}_{l} ‖}^{2} = 2 Re \{ {\tilde{G}}_{l}^{H} {\tilde{A}}_{l}^{H} ( {l}_{} ⊙ exp \{ - j Δ \hat{ψ} \} ) \} - {\tilde{G}}_{l}^{H} {\tilde{A}}_{l}^{H} {\tilde{A}}_{l} {\tilde{G}}_{l} ,$$

where Gₗ≐G(Ω̅ₗ^{RIS,1}, Ω̅ₗ^{RIS,2}, d_{in,l}, d_{re,l}, Φ_{p,k}) denotes a response to the RIS, and the response to the RIS is related to the angle of incidence Ωₗ^{RIS,1} and the angle of reflection Ωₗ^{RIS,2} at the RIS end, \tilde{G}ₗ denotes a matrix transformation of Gₗ, Δ\hat{Ψ} denotes an estimated value for an initial phase introduced by a plurality of measurements, Ãₗ denotes a matrix transformation of the polarization matrix parameters described in Step 301.

In Step 303, a partial derivative of the log-likelihood function is solved, and it is let that

$$\frac{Λ ( {\overline{Ω}}_{l}^{RIS , 1} , {\overline{Ω}}_{l}^{RIS , 2} ; {d}_{i n , l} , {d}_{re , l} )}{\partial {\tilde{A}}_{l}} = 0$$

such that an objective function for the likelihood estimation of angle parameters and distance parameters of the RIS is obtained.

In Step 304, the objective function is maximized to obtain an estimated value for additional parameters.

In Step 305, an estimated result of a parametric coupling polarization matrix is obtained based on the estimated values for the angle parameters and the distance parameters of the RIS:

$${\hat{A}}_{l} = {( {l}_{H}^{} {l}_{} )}^{- 1} {l}_{H}^{} {l}_{} ⊙ exp \{ - j Δ \hat{ψ} \} ,$$

where [symbol] ₗ and [symbol] ₗ denote an estimated value for \tilde{G}ₗ in S302 and an estimated value for the polarization matrix in S301, respectively.

Further, implements of Step 4 are specifically as follows. A parameter set is divided into corresponding parameter subsets, and a continuous updating iteration process of Step E and Step M of the SAGE algorithm are implemented in sequence until the channel parameters are iterated and converged. The result of the last iteration is an estimated value output by a channel parameter estimation method, Step E is a process of obtaining an observed data x_{l,k}(t) in a k-th transmission mode, a method of Step E is as follows: x_{l,k}(t)=yₖ(t)−Σₗ^{L}sₖ(t; \hat{θ}_{l,k}),

where, \hat{θ}_{l,k} denotes a parameter set of an l-th path in the k-th transmission mode estimated in the previous iteration, yₖ(t) denotes received signals obtained in the k-th transmission mode, and Σₗ^{L-1}sₖ(t; \hat{θ}_{l,k}) denotes a sum of signals of other L-1 paths in the environment except the l-th path. Step M is a process of searching parameter values and solving parameter values that maximize the objective function in Step 302.

The method for estimating channel parameters of the reconfigurable intelligent surface based on the spherical wave assumption is simulated to evaluate the performance of the method. The root-mean square estimation error (RMSE) is used as the criterion to evaluate the performance of the method, and the influences of the number of the RIS transmission modes and the size of the RIS specifications on the performance of the method are investigated. The simulation results are the average of 500 Monte Carlo tests. The simulation parameters are set as shown in Table 1.

TABLE 1
Simulation Parameters Settings

| Parameters | Values |
|---|---|
| The number of antennas at transmitter | 32 |
| The number of antennas at receiver | 64 |
| Carrier frequency | 5.4 GHz |
| Bandwidth | 320 MHz |
| Total number of the multipaths | 20 |
| Total number of multipaths passing | 5 |
| through RIS | |
| Delay | Random, generated according to |
| | the 3GPP standard protocol |
| Angle of arrival, angle of departure, | Random, generated according to |
| angle of reflection, angle of incidence | the 3GPP standard protocol |
| Distance parameters at the RIS end | Random, generated according to |
| | the 3GPP standard protocol |
| Doppler shift | Random, generated according to |
| | the 3GPP standard protocol |
| Complex amplitude | Random, generated according to |
| | the 3GPP standard protocol |

The RMSE results obtained by the proposed algorithm based on the near-field spherical wave assumption in different parameter configurations are as illustrated in FIG. 3. It can be seen from FIG. 3 that the RMSE decreases with the increase of the signal-to-noise ratio (SNR) in the same parameter configuration. In addition, under circumstance of the same SNR, the RMSE decreases with the increase on the number of the transmission modes, that is, the estimation accuracy increases. This is because the increasing of the transmission modes brings more large-dimensional posterior data, which is conducive to improving the accuracy of the estimation of the angle and distance parameters at the RIS end. In addition, in the same SNR and the same number of the transmission modes, a larger RIS may bring a lower RMSE, because the estimation accuracy of the RIS angle parameters improves with the increasing of the RIS scale.

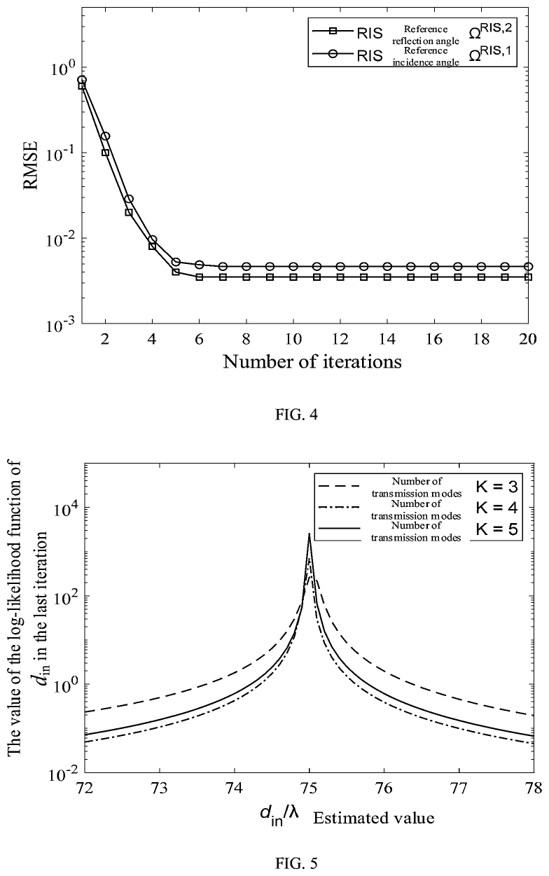

The variation trend on RMSE of the RIS angle parameters {Ω̅ₗ^{RIS,1}, Ω̅ₗ^{RIS,2}} with the number of iterations is as illustrated in FIG. 4. It can be seen from FIG. 4, in the initial iteration process, the RMSE decreases with the increase of the iterations, and after approximately the sixth iteration process, the variation on RMSE gradually stabilizes and tends to converge, indicating that the proposed algorithm has good convergence for the estimation of the RIS angle parameters.

The result of the likelihood function used to estimate the distance parameters at the RIS end during the process of last iteration is as illustrated in FIG. 5, the distance d_{in,1} is quantized by the signal wavelength λ, and the theoretical value of d_{in,1} is set as 75 λ herein. It can be seen from FIG. 5 that, for the number of different transmission modes, the maximum likelihood functions may reach the maximum values at the theoretical values, however with the increase on the number of the transmission modes, the maximum values increase gradually. A larger maximum value means a better anti-interference of the algorithm estimation, thus determining that the fuzziness of the estimated value is less, and the estimation error is smaller.

It can be seen from the instance that the method provided by the present disclosure can be well applied to the terms of parameter estimations of the RIS assisted near-field channels, and compared with the prior art, the method provided by the present disclosure has the following advantages. Firstly, the method provided by the present disclosure is suitable for the RIS assisted near-field wireless communication scenarios. Secondly, the estimations on the angle parameters, the distance parameters and the coupling polarization matrix of the RIS end are implemented. Thirdly, the accuracy of the obtained parameter estimated values is extremely high.

It can be understood that the present disclosure is described by a plurality of embodiments, it is known for those skilled in the art that the features and embodiments may be modified or equivalently replaced without deviating from the spirit and scope of the present disclosure. In addition, under the teaching of the present disclosure, these features and embodiments may be modified to adapt to specific situations and materials without deviating from the spirit and scope of the present disclosure. Therefore, the present disclosure is not limited by the specific embodiments disclosed herein, and all embodiments falling within the scope of the claims of the present application fall within the protection scope of the present disclosure.

What is claimed is:

1. A method for estimating channel parameters of a reconfigurable intelligent surface based on a spherical wave assumption, comprising following steps:
Step 1, constructing, based on the spherical wave assumption, a signal model of a reconfigurable intelligent surface (RIS)-assisted near-field communication;
Step 2, acquiring channel measurement data in different RIS transmission modes;
Step 3, estimating, based on a space-alternating generalized expectation maximization (SAGE) algorithm, a delay, an angle of arrival, an angle of departure, a Doppler shift and a polarization matrix of multipath components in channels, and estimating, based on a maximum likelihood principle, angle parameters, distance parameters and coupling polarization matrices of the multipath components at a RIS end; and
Step 4, updating and iterating estimated parameters subsequently.

2. The method for estimating the channel parameters of the reconfigurable intelligent surface based on the spherical wave assumption according to claim 1, wherein Step 1 specifically includes follows steps:
Step 101, considering an existing RIS-assisted MIMO wireless communication environment, wherein antenna arrays with scales of Mₜ and Mᵣ are equipped at a transmitter and a receiver respectively; setting the RIS as a planar array formed by M_{RIS}=Mₓ×M_{y} passive electromagnetic reflection unit cells with irregular reflection functions; setting a total of L multipath components to interact with the RIS in a channel environment, wherein propagation characteristics of the L multipath components are affected by the RIS and a whole propagation link of transmitter(Tx)-RIS-receiver(Rx) is divided into sub-links of transmitter-RIS and RIS-receiver; expressing polarization matrices in each of the sub-links as Aₗ^{Tx-RIS} and Bₗ^{RIS-Rx}; expressing, in the wireless communication environment, a signal vector s^{RIS}(t; θₗ) as:
$${s}^{RIS} ( t ; {θ}_{l} ) = {[ {s}_{1}^{RIS} ( t ; {θ}_{l} ) , … , {s}_{{M}_{r}}^{RIS} ( t ; {θ}_{l} ) ]}^{T} = exp \{ j 2 π {v}_{l} t \} {C}_{r} ( {Ω}_{l}^{r} ) {\underbrace{{{[ {B}_{l}^{RIS - Rx} ]}^{T} [ \begin{matrix}0 & {G}_{2} \\ {G}_{1} & 0\end{matrix} ] [ {A}_{l}^{Tx - RIS} ]}^{T}}}_{{A}_{l}} \cdot {{C}_{t} ( {Ω}_{l}^{t} )}^{T} u ( t - {τ}_{l} ) ,$$
where u(t)=[u₁(t), u₂(t), . . . , u_{M}_{ₜ}(t)]^{T} denotes transmitting signals, θₗ denotes a set of parameters in an l-th path formed by a delay τₗ, an angle of departure Ωₗ^{t}, an angle of arrival Ωₗ^{r}, a Doppler shift νₗ and a polarization matrix Aₗ, and the polarization matrix Aₗ includes complex amplitude information of horizontal and vertical polarization directions, Cᵣ(Ωₗ^{r})≐[C_{r,1}(Ωₗ^{r}), C_{r,2}(Ωₗ^{r})]∈ [symbol] ^{M}^{ᵣ}^{×2} denotes antenna response at the receiver, Cₜ(Ωₗ^{t})≐[C_{t,1}(Ωₗ^{t}), C_{t,2}(Ωₗ^{t})]∈ [symbol] ^{M}^{ₜ}^{×2} denotes antenna response at the transmitter, the antenna responses to the transmitter are measured in a microwave darkroom, G₁ denotes responses of the RIS to incoming waves from a horizontal polarization direction, G₂ denotes responses of the RIS to incoming waves from a vertical polarization direction; and
Step 102, in a setting of a RIS near-field spherical wave, for the transmitter-RIS link, electromagnetic waves from the transmitter or other scatterers in the environment arriving at different electromagnetic reflection unit cells of the RIS at different angles, wherein values for the angles are related to positions of the electromagnetic reflection unit cells on the RIS;
setting an electromagnetic reflection unit cell at a center position as a reference unit cell, expressing a position vector of the reference unit cell as r̅_{RIS}; expressing a position vector of an m-th reflection unit cell on the RIS as r_{RIS,m}; expressing, for a path l passing through a scatterer or ejected from the transmitter to the RIS, a position vector of the scatterer in the RIS coordinate system as s_{in,l}, wherein a distance between the scatterer and a center of the RIS is d_{in,l}, and the d_{in,l} is less than a Rayleigh distance of the RIS, and a reference angle of incidence from the path l to the reference unit cell on the RIS is Ω̅ₗ^{RIS,1}, then the position vector of the scatterer s_{in,l} is denoted as:
$${s}_{i n , l} = - {d}_{i n , l} {\overline{Ω}}_{l}^{RIS , 1} .$$

3. The method for estimating the channel parameters of the reconfigurable intelligent surface based on the spherical wave assumption according to claim 2, according to the position vector r_{RIS,m} of the m-th reflection unit cell, Ω̅ₗ^{RIS,1} and d_{in,l}, an angle of incidence from the path l to the m-th electromagnetic reflection unit cell on the RIS is obtained as:
$${Ω}_{l , m}^{RIS , 1} = \frac{( {r}_{RIS , m} - {\overline{r}}_{RIS} ) - {s}_{i n , l}}{‖ ( {r}_{RIS , m} - {\overline{r}}_{RIS} ) - {s}_{i n , l} ‖} = \frac{( {r}_{RIS , m} - {\overline{r}}_{RIS} ) + {d}_{i n , l} {\overline{Ω}}_{l}^{RIS , 1}}{‖ ( {r}_{RIS , m} - {\overline{r}}_{RIS} ) + {d}_{i n , l} {\overline{Ω}}_{l}^{RIS , 1} ‖} ,$$
where ∥⋅∥ denotes an modulo operation;
an angle of reflection of the path l reflected by the RIS to other scatters or the receiver in the RIS-Rx link is related to the positions of the electromagnetic reflection unit cells of the RIS, and an angle of reflection of the path l passing through the m-th electromagnetic reflection unit cell is represented as:
$${Ω}_{l , m}^{RIS , 2} = \frac{( {r}_{RIS , m} - {\overline{r}}_{RIS} ) - {s}_{re , l}}{‖ ( {r}_{RIS , m} - {\overline{r}}_{RIS} ) - {s}_{re , l} ‖} = \frac{( {r}_{RIS , m} - {\overline{r}}_{RIS} ) + {d}_{re , l} {\overline{Ω}}_{l}^{RIS , 2}}{‖ ( {r}_{RIS , m} - {\overline{r}}_{RIS} ) + {d}_{re , l} {\overline{Ω}}_{l}^{RIS , 2} ‖} ,$$
where s_{re,l} denotes a position vector of the scatter, d_{re,l} denotes a distance from the scatterer to the center of the RIS, Ω̅ₗ^{RIS,2} denotes a reference angle of reflection of the path l reflected from the reference unit cell on the RIS to the scatterer; further, RIS guidance vectors c^{RIS,1} and c^{RIS,2} based on a spherical wave setting are obtained as:
$${C}_{RIS , 1} ( {\overline{Ω}}_{l}^{RIS , 1} , {d}_{i n , l} ) = {[ \begin{matrix}\begin{matrix}exp \{ j 2 {πλ}^{- 1} ( {Ω}_{l , 1}^{RIS , 1} \cdot {r}_{RIS , 1} ) \} \\ ⋯\end{matrix} \\ \begin{matrix}exp \{ j 2 π {λ}^{- 1} ( {Ω}_{l , m}^{RIS , 1} \cdot {r}_{RIS , m} ) \} \\ ⋯\end{matrix} \\ exp \{ j 2 π {λ}^{- 1} ( {Ω}_{l , {M}_{RIS}}^{RIS , 1} \cdot {r}_{RIS , {M}_{RIS}} ) \}\end{matrix} ]}_{{M}_{RIS} \times 1} , \\ {C}_{RIS , 2} ( {\overline{Ω}}_{l}^{RIS , 2} , {d}_{re , l} ) = {[ \begin{matrix}\begin{matrix}exp \{ j 2 π {λ}^{- 1} ( {Ω}_{l , 1}^{RIS , 2} \cdot {r}_{RIS , 1} ) \} \\ ⋯\end{matrix} \\ \begin{matrix}exp \{ j 2 π {λ}^{- 1} ( {Ω}_{l , m}^{RIS , 2} \cdot {r}_{RIS , m} ) \} \\ ⋯\end{matrix} \\ exp \{ j 2 π {λ}^{- 1} ( {Ω}_{l , {M}_{RIS}}^{RIS , 2} \cdot {r}_{RIS , {M}_{RIS}} ) \}\end{matrix} ]}_{{M}_{RIS} \times 1} .$$

4. The method for estimating the channel parameters of the reconfigurable intelligent surface based on the spherical wave assumption according to claim 3, wherein Step 2 refers to obtaining required channel measurement data through measuring a plurality of times and manually adjusting transmission modes of the RIS each time, the transmission modes of the RIS refer to a set of regulation configurations of tuneable phase-shifts in RIS unit cell arrays.

5. The method for estimating the channel parameters of the reconfigurable intelligent surface based on the spherical wave assumption according to claim 4, wherein Step 3 specifically includes:
Step 301, obtaining, by utilizing received data, channel delays, angles of arrival, angles of departure, Doppler shifts and polarization matrix parameters in different transmission modes based on a SAGE algorithm;
Step 302, calculating, based on a complex amplitude [symbol] estimated in different transmission modes, a log-likelihood function of RIS-related parameters:
$$Λ ( {\overline{Ω}}_{l}^{RIS , 1} , {\overline{Ω}}_{l}^{RIS , 2} ; {d}_{i n , l} , {d}_{re , l} ) ∝ {‖ {l}_{} ⊙ exp \{ - j Δ \hat{ψ} \} - {\tilde{A}}_{l} {\tilde{G}}_{l} ‖}^{2} = 2 Re \{ {\tilde{G}}_{l}^{H} {\tilde{A}}_{l}^{H} ( {l}_{} ⊙ exp \{ - j Δ \hat{ψ} \} ) \} - {\tilde{G}}_{l}^{H} {\tilde{A}}_{l}^{H} {\tilde{A}}_{l} {\tilde{G}}_{l} ,$$
where Gₗ≐G(Ω̅ₗ^{RIS,1}, Ω̅ₗ^{RIS,2}, d_{in,l}, d_{re,l}, Φ_{p,k}) denotes a response to the RIS, and the response to the RIS is related to an angle of incidence Ωₗ^{RIS,1} and an angle of reflection Ωₗ^{RIS,2} at a RIS end, \tilde{G}ₗ denotes a matrix transformation of Gₗ, Δ\hat{Ψ} denotes an estimated value for an initial phase introduced by a plurality of measurements, Ãₗ denotes a matrix transformation of the polarization matrix parameters in Step 301;
Step 303, solving a partial derivative of the log-likelihood function and letting
$$\frac{Λ ( {\overline{Ω}}_{l}^{RIS , 1} , {\overline{Ω}}_{l}^{RIS , 2} ; {d}_{i n , l} , {d}_{re , l} )}{\partial {\tilde{A}}_{l}} = 0$$
to obtain an objective function for a likelihood estimation of angle parameters and distance parameters of the RIS;
Step 304, maximizing the objective function to obtain an estimated value for additional parametersand
Step 305, obtaining, based on the estimated values for the angle parameters and the distance parameters of the RIS, an estimated result of a parametric coupling polarization matrix:
$${\hat{A}}_{l} = {( {l}_{H}^{} {l}_{} )}^{- 1} {l}_{H}^{} {l}_{} ⊙ exp \{ - j Δ \hat{ψ} \} ,$$
where [symbol] ₗ denotes an estimated value for the \tilde{G}ₗ in S302, [symbol] ₗ denotes an estimated value for the polarization matrix in S301.

6. The method for estimating the channel parameters of the reconfigurable intelligent surface based on the spherical wave assumption according to claim 5, wherein implements of Step 4 are specifically as:
dividing a parameter set into corresponding parameter subsets, and implementing a continuous updating iteration process of Step E and Step M of the SAGE algorithm in sequence until the channel parameters are iterated and converged; a result of a last iteration being an estimated value output by a channel parameter estimation method, wherein Step E is a process of obtaining observed data x_{l,k}(t) in a k-th transmission mode, a method of Step E is as:
$${x}_{l , k} ( t ) = {y}_{k} ( t ) - {\sum }_{l}^{L} {s}_{k} ( t ; {\hat{θ}}_{l , k} ) ,$$
where, \hat{θ}_{l,k} denotes a parameter set of an l-th path in the k-th transmission mode estimated in a previous iteration, yₖ(t) denotes received signals obtained in the k-th transmission mode, and Σₗ^{L-1}sₖ(t; \hat{θ}_{l,k}) denotes a sum of signals of other L-1 paths in the environment except the l-th path; Step M is a process of searching parameter values and solving parameter values that maximize the objective function in Step 302.
